(19) United States
(12) Patent Application Publication
(10) Pub. No.: US 2007/0286231 A1
(43) Pub. Date: Dec. 13, 2007

(54) OPTICAL SIGNAL TRANSMITTING AND RECEIVING APPARATUS

(75) Inventors: Wataru KUBO, Saitama (JP); Shinichi ARAI, Tokyo (JP); Koichi TSUTAMURA, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/751,161

(22) Filed: May 21, 2007

(30) Foreign Application Priority Data
May 29, 2006 (JP) 2006-147812

(51) Int. Cl. H04J 15/00; H04B 10/00

(52) U.S. Cl. 370/464

(57) ABSTRACT

An endoscope system comprises an electric scope and a processor. The electric scope has a signal emitting unit that radiates a digitized optical signal and an optical cable that transmits the digitized optical signal from the signal emitting unit. The processor has a first signal receiving unit that receives the digitized optical signal from the signal emitting unit through the optical cable and a control-signal emitting unit that radiates a control signal that is converted to an optical signal. The electric scope has a control-signal receiving unit that receives a radiated light of the control signal that is radiated from the processor, through the optical cable. The signal emitting unit has an emitting surface that is parallel to a receiving surface of the control-signal receiving unit.

### BACKGROUND OF THE INVENTION

1. Field of the Invention

The present invention relates to an optical signal transmitting and receiving apparatus, and in particular an arrangement of an emitting unit and a receiving unit of the apparatus to effectuate downsizing.

2. Description of the Related Art

An optical signal transmitting and receiving apparatus that transmits an optical signal including information, is proposed.

Japanese unexamined patent publication (KOKAI) No. 2004-96299 discloses an optical signal transmitting apparatus that transmits the optical signal including information, detects the quantity of the transmitted light based on the light reflected by the optical fiber, and adjusts the quantity of the transmitting light.

However, an emitting surface of the signal-emitting unit that radiates the optical signal is perpendicular to a receiving surface of the signal-receiving unit that receives the radiated light for detecting the quantity of light. Therefore, this optical signal transmitting apparatus is enlarged.

### SUMMARY OF THE INVENTION

Therefore, an object of the present invention is to provide an optical signal transmitting and receiving apparatus that transmits the optical signal including information without enlargement.

According to the present invention, an optical signal transmitting and receiving apparatus comprises a first signal transmitting and receiving unit and a second signal transmitting and receiving unit.

The first signal transmitting and receiving unit has a signal emitting unit that radiates a digitized optical signal, and an optical cable that transmits the digitized optical signal from the signal emitting unit.

The second signal transmitting and receiving unit has a first signal receiving unit that receives the digitized optical signal from the signal emitting unit through the optical cable, and a control-signal emitting unit that radiates a control signal that is converted to an optical signal.

The first signal transmitting and receiving unit has a control-signal receiving unit that receives a light signal pertaining to the control signal that is radiated from the second signal transmitting and receiving unit through the optical cable.

The signal emitting unit has an emitting surface that is parallel to a receiving surface of the control-signal receiving unit.

### BRIEF DESCRIPTION OF THE DRAWINGS

The objects and advantages of the present invention will be better understood from the following description, with reference to the accompanying drawings in which:

FIG. 1 is a block diagram of the endoscope of the first, second, and third embodiments;

FIG. 2 is a side view of the imaging unit in the first embodiment;

FIG. 3 is a side view of the molding package and the optical cable that separates them in the first embodiment;

FIG. 4 is a side view of the imaging unit in the second embodiment;

FIG. 5 is a side view of the imaging unit in the third embodiment,

FIG. 6 is a construction diagram of the diffraction grating board in the third embodiment, and

FIG. 7 is a different embodiment compared to FIG. 3, and is a side view of where the molding package and the optical cable are separated in the first embodiment.

### DESCRIPTION OF THE PREFERRED EMBODIMENTS

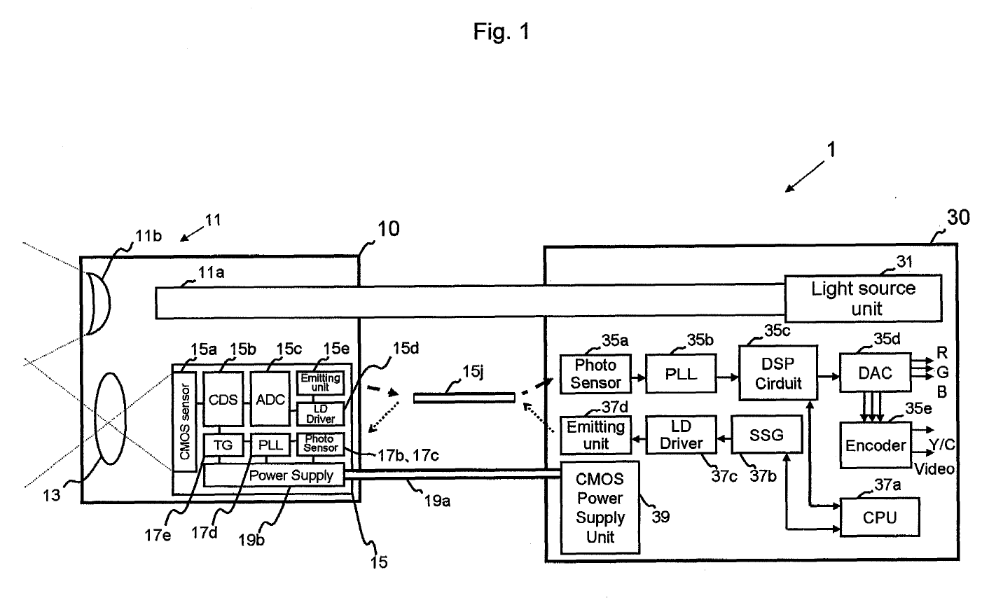

The present invention is described below with reference to the embodiments shown in the drawings. In the first embodiment, an electric endoscope system 1 is explained by the example of an optical cable connecting apparatus. As shown in FIG. 1, the electric endoscope system 1 relating to the first embodiment of the present invention is provided with an electric scope 10 as a source of the video signal, and a processor 30 as a source of the control signal.

The electric scope 10 has a lighting unit 11, an objective optical system 13, and an imaging unit 15 at the distal end part of the electric scope 10. The imaging unit 15 images a body (a hollow interior of an organ) etc., which is the photographic subject that is illuminated by the lighting unit 11, through the objective optical system 13.

The lighting unit 11 has a light guide 11a and a lens for lighting 11b.

The imaging unit 15 has a CMOS sensor 15a, a CDS (Correlated Double Sampling) circuit 15b, an ADC (Analog Digital Converter) 15c, a video-signal LD driver 15d, a video-signal emitting unit 15e that is a VCSEL (Vertical Cavity Surface Emitting Laser etc.), a first glass board 15f1, a second glass board 15f2, a first lens 15h1, a second lens 15h2, a first prism 15i1, a second prism 15i2, a scope-side condenser lens 15i3, an optical cable 15j, a control-signal photo sensor unit 17b that is a PD (Photo Diode etc.), a control-signal amplifier 17c, a control-signal PLL decoder 17d, a TG (Timing Generator) 17e, a logic IC 17z, a power supply cable 19a, and a power supply unit 19b.

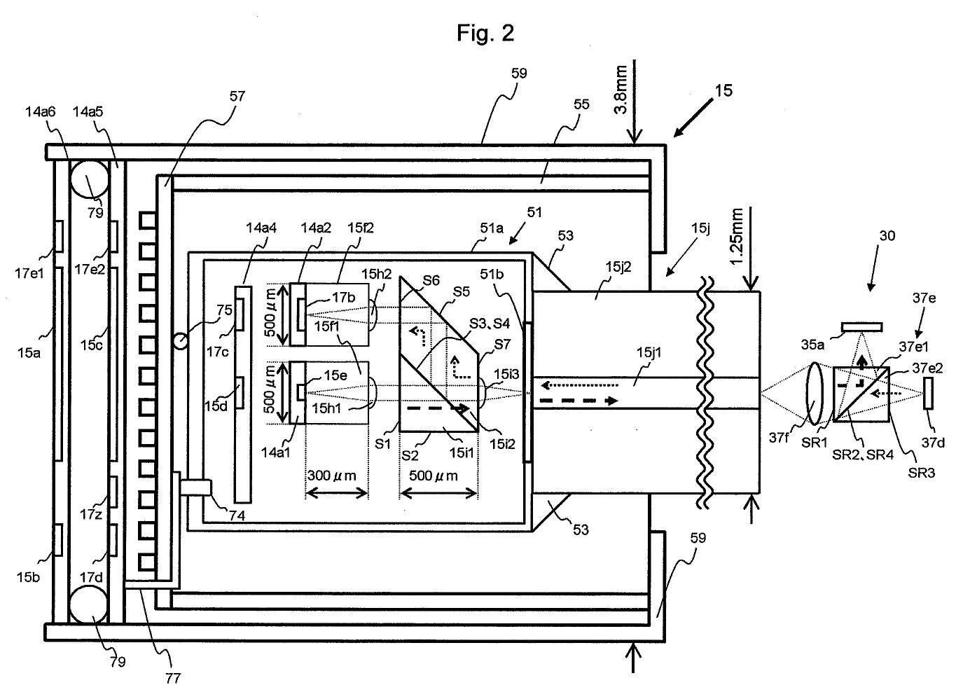

The TG 17e has a sub TG 17e1 and a main TG 17e2 (see FIG. 2).

The processor 30 supplies both light and electric power to the electric scope 10, performs an image processing operation on the image signal of the photographing subject imaged by the electric scope 10, and converts the image signal to a video signal that can be displayed on a TV monitor (not depicted).

The processor 30 has a light source unit 31, a first video-signal photo sensor unit 35a that is a PD etc., a video-signal PLL decoder 35b, a DSP circuit 35c, a DAC (Digital Analog Converter) 35d, an encoder 35e, a CPU 37a, a SSG (Synchronizing Signal Generator) 37b, a control-signal LD driver 37c, a control-signal emitting unit 37d that is a FP-LD (Fabry-Perot Laser Diode) etc., a wavelength-separation prism 37e, a processor-side condenser lens 37f, and a CMOS power supply unit 39.

The light source unit 31 is a lighting circuit that has a xenon lamp light source etc., that emits a light that illuminates the photographing subject. The light from the light source unit 31 reaches the photographing subject from the distal end part of the electric scope 10 after traveling through the light guide 11a and the lens for lighting 11b.

The photographing subject is imaged as an optical image through the objective optical system 13 by the CMOS sensor 15a. The optical image is processed by the DSP circuit 35c of the processor 30, after correlated double sampling and A/D conversion have been carried out by the CDS 15b and the ADC 15c, respectively.

In the first embodiment, the CMOS sensor is used as the imaging sensor. Because the amplifier for the CMOS sensor is arranged near the photo sensor (the CMOS sensor) that receives the light, there is a lower occurrence of signal noise compared to when a CCD sensor is used as the imaging sensor.

Further, because a single power supply providing +3.3 volts is used for driving, there is merit in the small amount of wiring between the distal end part of the electric scope 10 and the processor 30.

Transmission of the image signal from the ADC 15c of the electric scope 10 to the DSP circuit 35c of the processor 30 is accomplished via light. Specifically, the image signal is converted to a digital signal by the ADC 15c, then converted to a serial signal from the parallel signal by the logic IC 17z, and then converted to an on/off light signal (the light signal) by the video-signal LD driver 15d, whereupon the on/off light signal flashes on and off at the video-signal emitting unit 15e, which in turn is driven by the pulse.

The on/off light signal then travels through the first glass board 15f1, the first lens 15h1, the first prism 15i1, the second prism 15i2, the scope-side condenser lens 15i3, the optical cable 15j, the processor-side condenser lens 37f, and the wavelength-separation prism 37e before it is received and amplified by the first video-signal photo sensor unit 35a. Next, the signal is decoded by the video-signal PLL decoder 35b, after which the decoded signal undergoes an image signal processing operation performed by the DSP circuit 35c. The logic IC 17z has been omitted from FIG. 1.

The value of the oscillating wavelength of the light that is radiated from the video-signal emitting unit 15e is set to approximately 850 nm, which is infrared ray.

Therefore, the signal deterioration (loss) between the electric scope 10 and the processor 30 can be reduced in comparison to when an analog electric signal is transmitted from the electric scope 10 to the processor 30.

Further, because a digital electric signal is converted to the light signal that is transmitted from the electric scope 10 to the processor 30, an additional amount of information can be transmitted compared to when an analog electric signal is converted to the transmitted light signal.

For example, in the where that the electric scope 10 has a VGA (640×480≈30 mega pixels) CMOS sensor, a frame rate of 30 frames per second, and a color gradation of 10 bits (1024 steps), the transmitting speed by which the number of pixels, the frame rate, and the color gradation are multiplied is approximately 92 Mbps. When the analog electric signal is transmitted from the electric scope 10 to the processor 30 by using a thin wire cable, it is difficult to transmit the image signal at a transmission speed beyond 100 to 200 Mbps without phase delay.

However, when the digital light signal is transmitted in the first embodiment, the image signal can be transmitted without phase delay at high transmission speeds beyond 1 Gbps, corresponding to high density pixels, a high frame rate, and a high color gradation.

After the image processing operation by the DSP circuit 35c and the D/A conversion by the DAC 35d, the video signal, which is separated for Y/C by the encoder 35e, and the analog RGB component signal etc. are transmitted to the TV monitor (not depicted), which displays them as the image signal.

The CPU 37a controls each part of the electric scope 10 and the processor 30. In particular, trigger signals for AGC (Auto Gain Control), for AE (Auto Exposure), and for obtaining the freeze photograph are transmitted to the electric scope 10 as the command control signal from the CPU 37a through the SSG 37b etc.

Specifically, the SSG 37b generates a pulse signal (a synchronizing signal) controlled by the CPU 37a. The synchronizing signal is converted to the on/off light signal based on the pulse of the control-signal LD driver 37c, and the on/off light signal flashes on and off at the control-signal emitting unit 37d that is driven by the pulse.

The on/off light signal travels through the wavelength-separation prism 37e, the processor-side condenser lens 37f, the optical cable 15j, the scope-side condenser lens 15i3, the second prism 15i2, the second lens 15h2, and the second glass board 15f2 before it is received by the control-signal photo sensor unit 17b that has a photo diode. The on/off light signal is then amplified by the control-signal amplifier 17c and decoded by the control-signal PLL decoder 17d.

The value of the oscillating wavelength of the light that is radiated from the control-signal emitting unit 37d is set to approximately 650 nm, which is red light.

The TG 17e outputs a clock pulse based on the signal decoded by the control-signal PLL decoder 17d. The main TG 17e2 outputs a clock pulse (a timing pulse) for the ADC 15c etc. The sub TG 17e1 converts the clock pulse that is output from the main TG 17e2 to a clock pulse for the CMOS sensor 15a and the CDS 15b, and then outputs the converted clock pulse to the CMOS sensor 15a and the CDS 15b.

The operations of the CMOS sensor 15a, the CDS 15b, and the ADC 15c are performed according to the clock pulse output from the TG 17e.

The CMOS power supply unit 39 of the processor 30 supplies the electric power to the power supply unit 19b of the electric scope 10 through the power supply cable 19a. The power supply unit 19b supplies the electric power to each part of the electric scope 10, such as the imaging unit 15 etc.

In the first embodiment, the supply of the electric power from the processor 30 to the electric scope 10 is delivered through the power supply cable 19a; however, the supply of the electric power may be delivered through the light guide 11a. Specifically, a solar battery is arranged at the distal end part of the electric scope 10 that has the CMOS sensor 15a. A potion of the light passing through the light guide 11a is converted to electric energy by the solar battery, and the electric power based on the converted electric energy is supplied to each part of the electric scope 10.

In this construction the CMOS power supply unit 39 and power supply cable 19a are not necessary, thus reducing the diameter required of the cable connecting part of the electric scope 10 with both the processor 30 and the distal end part of the electric scope 10. Furthermore, external noise interference can be mitigated and isolation can be improved between the distal end part of the electric scope 10 and the processor 30, effectively decreasing the potential of an accidental electric shock caused by the high voltage power supply of the xenon lamp of the light source 31.

The optical cable 15j has an optical fiber core 15j1 and an optical fiber protection ferrule 15j2. The diameter of the optical fiber core 15j1 is approximately 200 μm. The diameter of the optical fiber protection ferrule 15j2 that surrounds the optical fiber core 15j1 is approximately 1.25 mm.

One end of the optical fiber core 15j1 faces the video-signal emitting unit 15e through a cover glass window 51b, the scope-side condenser lens 15i3, the second prism 15i2, the first prism 15i1, the first lens 15h1, and the first glass board 15f1.

The other end of the optical fiber core 15i1 faces the control-signal emitting unit 37d through the processor-side condenser lens 37f and the wavelength-separation prism 37e.

Through the optical fiber core 15j1, the control signal is transmitted from the processor 30 to the electric scope 10, and the video signal is transmitted from the electric scope 10 to the processor 30.

A connection cable between the electric scope 10 and the processor 30 that is not depicted includes the optical fiber cable 15j and power supply cable 19a.

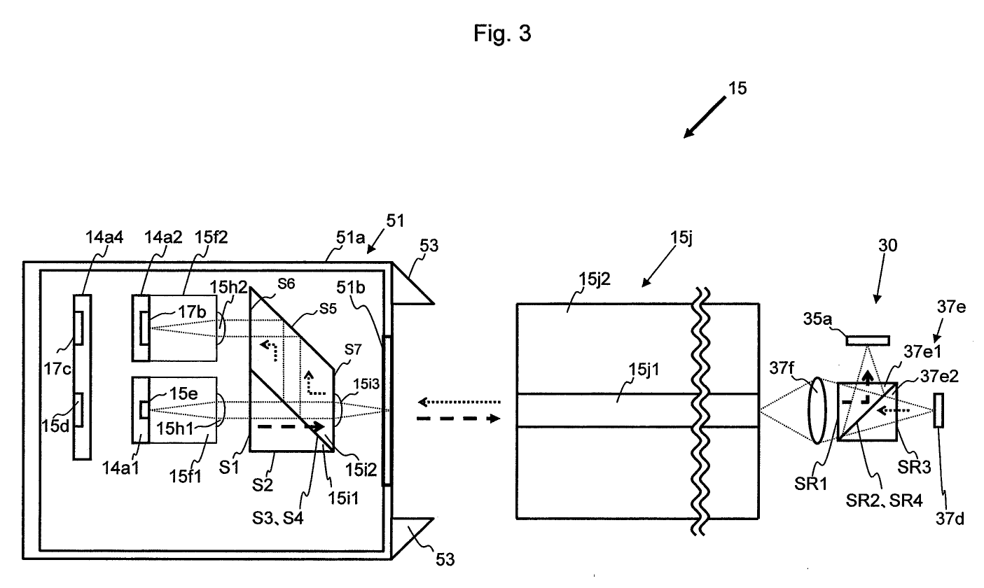

Next, the mounting part of the CMOS sensor 15a etc. is explained in the first embodiment (see FIGS. 2 and 3). The part regarding the power supply has been omitted from FIG. 2.

The imaging unit 15 has a first circuit board 14a1, a second circuit board 14a2, a fourth circuit board 14a4, a fifth circuit board 14a5, a sixth circuit board 14a6, a molding package 51, a positioning member 53, a metal case 55, a heat radiation board 57, and a board support unit 59 for the purpose of mounting.

The first circuit board 14a1, the second circuit board 14a2, the fourth circuit board 14a4, the fifth circuit board 14a5, and the sixth circuit board 14a6 are arranged parallel to the lens surface of the objective optical system 13. The first and second circuit boards 14a1 and 14a2 are arranged on the same plane.

The sixth circuit board 14a6, the fifth circuit board 14a5, the fourth circuit board 14a4, and the first circuit board 14a1 are arranged in order from the objective optical system 13 side.

The fifth and sixth circuit boards 14a5 and 14a6 are attached to the board support unit 59 whose diameter is approximately 3.8 mm.

The first, second, and fourth circuit boards 14a1, 14a2, and 14a4 are arranged in the molding package 51.

In the first embodiment, the first and second circuit boards 14a1 and 14a2 are separate from each other; however, they may be combined on one circuit board.

The molding package 51 is a container (case) that encloses a member that is used for transmitting the video signal and the control signal, such as the first prism 15i1 etc., and protects it from the outside air by using a resin etc. The molding package 51 has a body 51a and a cover glass window 51b.

The cover glass window 51b is a window that the light passes through for the optical signal output from and input to the optical fiber core 15j1 of the optical cable 15j. The contents of the molding package 51 are covered by its body 51a and the cover glass window 51b.

The first circuit board 14a1, the second circuit board 14a2, the fourth circuit board 14a4, the video-signal LD driver 15d, the video-signal emitting unit 15e, the first glass board 15f1, the second glass board 15f2, the first lens 15h1, the second glass lens 15h2, the first prism 15i1, the second prism 15i2, the scope-side condenser lens 15i3, the control-signal photo sensor unit 17b, and the control-signal amplifier 17c are positioned inside of the molding package 51.

The first circuit board 14a1 is electrically connected to the fourth circuit board 14a4 via a plurality of bump balls (not depicted). The second circuit board 14a2 is electrically connected to the fourth circuit board 14a4 via a plurality of bump balls (not depicted). The fourth circuit board 14a4 is electrically connected to the fifth circuit board 14a5 via a lead 74 that penetrates the body 51a of the molding package 51 and a flexible circuit board 77 that penetrates the radiation board 57.

The molding package 51 is attached to an area surrounded by the metal case 55 and the heat radiation board 57. The metal case 55 consists of surfaces that are parallel to the optical axis of the objective optical system 13, and surrounds the side surfaces of the molding package 51.

The heat radiation board 57 has a heat radiation fin that overhangs to the objective optical system 13 side in the optical axis direction of the objective optical system 13, from a plane of the heat radiation board 57 that is perpendicular to the optical axis of the objective optical system 13. The heat radiation board 57 radiates heat away from the molding package 51.

The body 51a of the molding package 51 is fixed to the heat radiation board 57 by an adhesive 75.

The fifth circuit board 14a5 is electrically connected to the sixth circuit board 14a6 via bump balls 79.

The metal case 55, the heat radiation board 57, the fifth circuit board 14a5, and the sixth circuit board 14a6 are attached to the board support unit 59.

On the opposite side of the objective optical system 13 of the molding package 51 (on the side in contact with the optical cable 15j), the positioning member 53 is attached. The positioning member 53 overhangs from the molding package 51 to the optical cable 15j side in the optical axis direction of the objective optical system 13.

The positioning member 53 has a shape that catches and engages the optical cable 15j.

The optical cable 15j is inserted into the board support unit 59 and engaged with the positioning member 53 under the condition where the positioning member 53 is attached to the molding package 51, so that the connection between the optical cable 15j and the molding package 51, and the positioning operation for the optical path can both be easily carried out (see FIG. 3).

The CMOS sensor 15a is mounted on the sixth circuit board 14a6, it consists of the CMOS sensor tip made of silicon, and it images the photographing subject through the objective optical system 13.

The CDS 15b and the sub TG 17e1 are mounted on the sixth circuit board 14a6. Therefore, the CMOS sensor 15a, the CDS 15b, and the sub TG 17e1 are each mounted with the same manufacturing process.

Because the CMOS sensor 15a needs an accurate control of read out, the sub TG 17e1 that controls the timing of the read out is arranged near the CMOS sensor 15a, making it easier to adjust the timing control of the start and end points of the read out.

Further, because both the interconnect and routing lengths can be restrained, the phase delay can be avoided and the enlargement of the circuit board can be prevented.

Further, if the number of pixels of the CMOS sensor 15a is increased in the future, the phase delay can be restrained and the speed of reading can be held constant, even if the operational speed is increased.

The ADC 15c, the control-signal PLL decoder 17d, the main TG 17e2, and the logic IC 17z are mounted on the fifth circuit board 14a5.

The video-signal LD driver 15d and the control-signal amplifier 17c are mounted on the fourth circuit board 14a4.

The video-signal emitting unit 15e and the first glass board 15f1 are arranged on the first circuit board 14a1 and on the opposite side of the objective optical system 13. The first circuit board 14a1 is composed of GaAs (Gallium Arsenic) circuit board material.

The second glass board 15f2 and the control-signal photo sensor unit 17b are arranged on the second circuit board 14a2 and on the opposite side of the objective optical system 13. The second circuit board 14a2 is composed of silicon circuit board material.

Next, a transmitting part of the optical signal in the first embodiment is explained.

The first glass board 15f1 is arranged on the first circuit board 14a1 and covers the video-signal emitting unit 15e. The first lens 15h1 is attached to the first glass board 15f1 on the opposite side of the objective optical system 13.

The second glass board 15f2 is arranged on the second circuit board 14a2 and covers the control-signal photo sensor unit 17b. The second lens 15h2 is attached to the second glass board 15f2 on the opposite side of the objective optical system 13.

The first lens 15h1 condenses the light of the video signal output from the video-signal emitting unit 15e, converts the radiated light to parallel light, and radiates the condensed parallel light to the first prism 15i1.

The second lens 15h2 condenses the light of the control signal output from the control-signal emitting unit 37d, and radiates the condensed light to the control-signal photo sensor unit 17b.

The thickness of the first glass board 15f1 and the second glass board 15f2 in the direction parallel to the optical axis of the objective optical system 13, is approximately 300 μm.

The thickness of the first glass board 15f1 and the second glass board 15f2 in the direction perpendicular to the optical axis of the objective optical system 13, is approximately 500 μm.

The first glass board 15f1 is used as the positioning member and focus adjusting member for the first lens 15h1.

The second glass board 15f2 is used as the positioning member and focus adjusting member for the second lens 15h2.

In the first embodiment, the value of the oscillating wavelength of the light that is radiated from the video-signal emitting unit 15e is set to approximately 850 nm. However, when this wavelength is set to approximately 990 nm, the radiated light passes through the GaAs circuit board without absorption by the GaAs circuit board. Accordingly, the first glass board 15f1 may be changed from the glass member to a GaAs circuit board that is the same as the first circuit board 14a1.

The first prism 15i1 and the second prism 15i2 combine to form the micro prism. The control signal that is radiated from the control-signal emitting unit 37d is reflected off the walls of the second prism 15i2 and output to the second lens 15h2 from the second prism 15i2.

The video signal that is radiated from the video-signal emitting unit 15e passes through the walls of the first and second prisms 15i1 and 15i2 and is output to one end of the optical fiber core 15j1 from the second prism 15i2.

The scope-side condenser lens 15i3 condenses the light (the video signal) that is radiated from the video-signal emitting unit 15e and then converted to parallel light by the first lens 15h1, and converts the light (the control signal) that is radiated from the control-signal emitting unit 37d and then output from the optical fiber core 15j1 to parallel light.

In the first embodiment, the first lens 15h1 converts the light (the video signal) radiated from the video-signal emitting unit 15e to parallel light, and the scope-side condenser lens 15i3 converts the light (the control signal) radiated from the control-signal emitting unit 37d to parallel light.

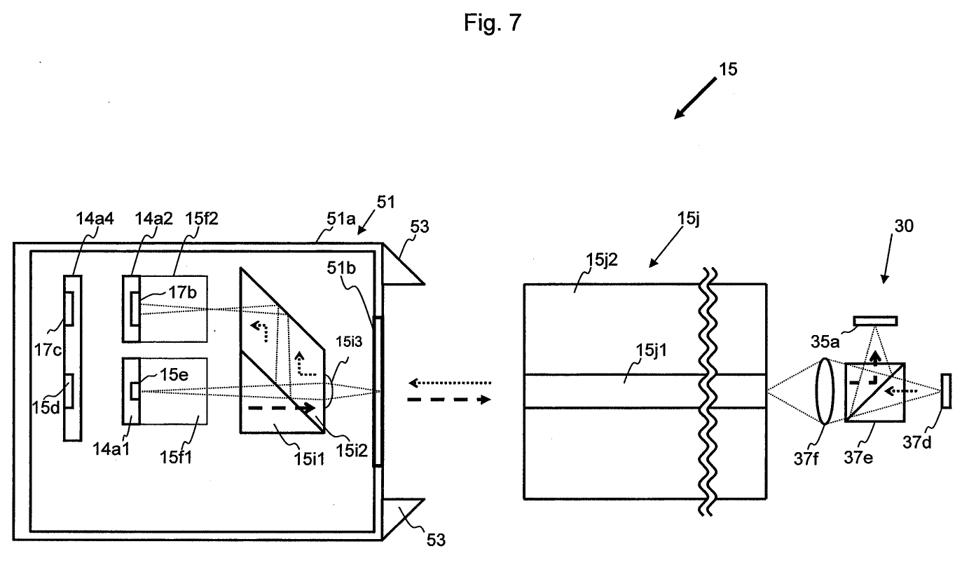

However, the conversion process to parallel light may be omitted (see FIG. 7). In this case, the light (the video signal) radiated from the video-signal emitting unit 15e is condensed by the scope-side condenser lens 15i3 without being converted to parallel light, and the light (the control signal) radiated from the control-signal emitting unit 37d is condensed by the scope-side condenser lens 15i3 without being converted to parallel light. Therefore, the first lens 15h1 and the second lens 15h2 are unnecessary.

A spacer (not depicted) is arranged between the first glass board 15f1 and the first prism 15i1, so that a constant distance is maintained between the first glass board 15f1 and the first prism 15i1 in the direction parallel to the optical axis of the objective optical system 13.

A spacer (not depicted) is arranged between the second glass board 15f2 and the second prism 15i2, so that a constant distance is maintained between the second glass board 15f2 and the second prism 15i2 in the direction parallel to the optical axis of the objective optical system 13.

The scope-side condenser lens 15i3 is arranged on the second prism 15i2 and in the optical path of the light radiated from the video-signal emitting unit 15e.

The first prism 15i1 has a first surface S1 that is perpendicular to the optical axis of the objective optical system 13, a second surface S2 that is perpendicular to the first surface, and a third surface S3 that intersects the optical axis of the objective optical system 13 at 45 degrees.

The first surface S1 of the first prim 15i1 faces the first lens 15h1.

The shape of the first prism 15i1 viewed from the side is an isosceles right triangle whose oblique side (base of the triangle) is the third surface S3.

The second prism 15i2 has two surfaces (a fourth surface S4 and a fifth surface S5) that intersect the optical axis of the objective optical system 13 at 45 degrees, and two surfaces (a sixth surface S6 and a seventh surface S7) that are perpendicular to the optical axis of the objective optical system 13.

The fourth surface S4 of the second prism 15i2 faces (contacts with) the third surface S3 of the first prism 15i1. The sixth surface S6 of the second prism 15i2 faces the second lens 15h2. The scope-side condenser lens 15i3 is attached to the seventh surface S7 of the second prism 15i2.

The shape of the second prism 15i2 viewed from the side is a parallelogram that consists of these four surfaces (the fourth, fifth, sixth, and seventh surfaces S4, S5, S6, and S7).

A wavelength separation coating is applied to at least one of the third surface S3 of the first prism 15i1 and the fourth surface S4 of the second prism 15i2.

The light that is radiated from the video-signal emitting unit 15e, whose oscillating wavelength is long (850 nm, see broken line in FIG. 2), is not reflected by (passes through) the third surface S3 of the first prism 15i1 and the fourth surface S4 of the second prism 15i2.

The light that is radiated from the control-signal emitting unit 37d, whose oscillating wavelength is short (650 nm, see dotted line in FIG. 2), is reflected by the fourth surface S4 of the second prism 15i2.

The thickness of the first prism 15i1 and the second prism 15i2 in the optical axis direction of the objective optical system 13 is approximately 500 μm.

The wavelength separation prism 37e has a first wavelength separation prism 37e1 and a second wavelength separation prism 37e2.

The first wavelength separation prism 37e1 has a first prism surface SR1 that is perpendicular to the optical axis of the objective optical system 13 and a second prism surface SR2 that intersects the optical axis of the objective optical system 13 at 45 degrees.

The shape of the first wavelength separation prism 37e1 viewed from the side is an isosceles right triangle whose oblique side (base of the triangle) is the second prism surface SR2.

Similarly, the second wavelength separation prism 37e2 has a third prism surface SR3 that is perpendicular to the optical axis of the objective optical system 13 and a fourth prism surface SR4 that intersects the optical axis of the objective optical system 13 at 45 degrees.

The shape of the second wavelength separation prism 37e2 viewed from the side is an isosceles right triangle whose oblique side (base of the triangle) is the fourth prism surface SR4.

The second prism surface SR2 of the first wavelength separation prism 37e1 is contacted to the fourth prism surface SR4 of the second wavelength separation prism 37e2.

The contact surface between the second prism surface SR2 of the first wavelength separation prism 37e1 and the fourth prism surface SR4 of the second wavelength separation prism 37e2 is coated with a wavelength-band separation finish that permits the passage of the light, whose oscillating wavelength is short, of the control signal radiated from the control-signal emitting unit 37d, but reflects the light, whose oscillating wavelength is long, of the video signal radiated from the video-signal emitting unit 15d.

The processor-side condenser lens 37f condenses the light of the control signal that is output from the control-signal emitting unit 37d and transmitted through the wavelength separation prism 37e to the processor 30 end of the optical cable 15j, and condenses the light of the video signal that is transmitted from the processor 30 end of the optical cable 15j to the first video-signal photo sensor unit 35a through the wavelength separation prism 37e.

In the first embodiment, by using the first prism 15i1 and the second prism 15i2, the direction of the light is separated, so that the arrangement between an emitting surface of the video-signal emitting unit 15e and the receiving surface of the control-signal photo sensor unit 17b can be parallel.

The separation of the transmitted light is performed by using refraction (passage of the video signal) and reflection (the control signal). The reflection of the control signal is performed once at the first prism 15i1 and once again at the second prism 15i2 therefore, the direction of the light of the control signal that is input to the control-signal photo sensor unit 17b can be parallel to the direction of the light of the video signal that is passed through.

Accordingly, both the video-signal emitting unit 15e and the control-signal photo sensor unit 17b can be mounted on circuit boards (the first and second circuit boards 14a1 and 14a2) that are configured on the same plane. In other words, the emitting surface of the video-signal emitting unit 15e and the receiving surface of the control-signal photo sensor unit 17b can be parallel.

Thus, the apparatus that transmits light and receives light for the electric scope 10 can be downsized in comparison to the apparatus that transmits light and receives light for the processor 30, where the photo sensor unit is arranged perpendicular to the emitting unit on two perpendicular planes by using the prism and the condenser lens in the processor 30.

Particularly, the depth direction that is parallel to the optical axis direction of the objective optical system 13 can be downsized.

In the case where one cable is shared for transmitting light from the processor 30 to the electric scope 10 and for transmitting light from the electric scope 10 to the processor 30, the apparatus that separates the light signal traveling in one direction (the video signal) from the signal traveling in the opposite direction (the control signal) is necessary.

In the first embodiment, due to comparatively small space on the electric scope side, the micro prism is used for separating the light signals so that the emitting unit and the photo sensor unit are arranged on the same plane. On the processor side, because space comparatively does exist, the prism is used for separating the light signals so that the emitting unit and the photo sensor unit are perpendicularly arranged on two planes that are perpendicular to each other. Therefore, the transmitting apparatus of the light and the receiving apparatus of the light can be appropriately arranged corresponding to the availability of space.

The distal end part of the electric scope 10 is approximately 10 mm in diameter. In consideration of the arrangement of the nozzle, the light guide 11a, and the throat of the forceps, it is desirable for the part housing the imaging unit 15, upon which the CMOS sensor 15a etc. are mounted, to have an appropriate shape and size so that it does not extend beyond the objective optical system 13 that is roughly 4 mm in diameter.

It is necessary to mount the peripheral circuits, such as the CDS 15b etc., near the CMOS sensor when it functions as the imaging sensor. In the first embodiment, however, the circuit board holding these peripheral circuits is oriented perpendicular to the optical axis of the objective optical system 13. Therefore, the peripheral circuits must be arranged accordingly so that the part housing the imaging unit 15 does not extend beyond the lens diameter of the objective optical system 13. The diameter of the board support unit 59 is approximately 3.8 mm.

Next, the second embodiment is explained. In the second embodiment, in contrast to the first embodiment, the imaging unit 15 receives light radiated from the video-signal emitting unit 15e and then the quantity of the radiated light is adjusted based on the quantity of the received light. The points that differ from the first embodiment are explained as follows.

The lighting unit 11 has a light guide 11a and a lens for lighting 11b.

The imaging unit 15 has a CMOS sensor 15a, a CDS (Correlated Double Sampling) circuit 15b, an ADC (Analog Digital Converter) 15c, a video-signal LD driver 15d, a video-signal emitting unit 15e that is a VCSEL (Vertical Cavity Surface Emitting Laser etc.), a first glass board 15f1, a second glass board 15f2, a third glass board 15f3, a first lens 15h1, a second lens 15h2, a third lens 15h3, a first prism 15i1, a second prism 15i2, a scope-side condenser lens 15i3, a second video-signal photo sensor unit 15k that is a PD etc., a video-signal amplifier 15m, an optical cable 15j, a control-signal photo sensor unit 17b that is a PD (Photo Diode) etc., a control-signal amplifier 17c, a control-signal PLL decoder 17d, a TG (Timing Generator) 17e, a logic IC 17z, a power supply cable 19a, and a power supply unit 19b.

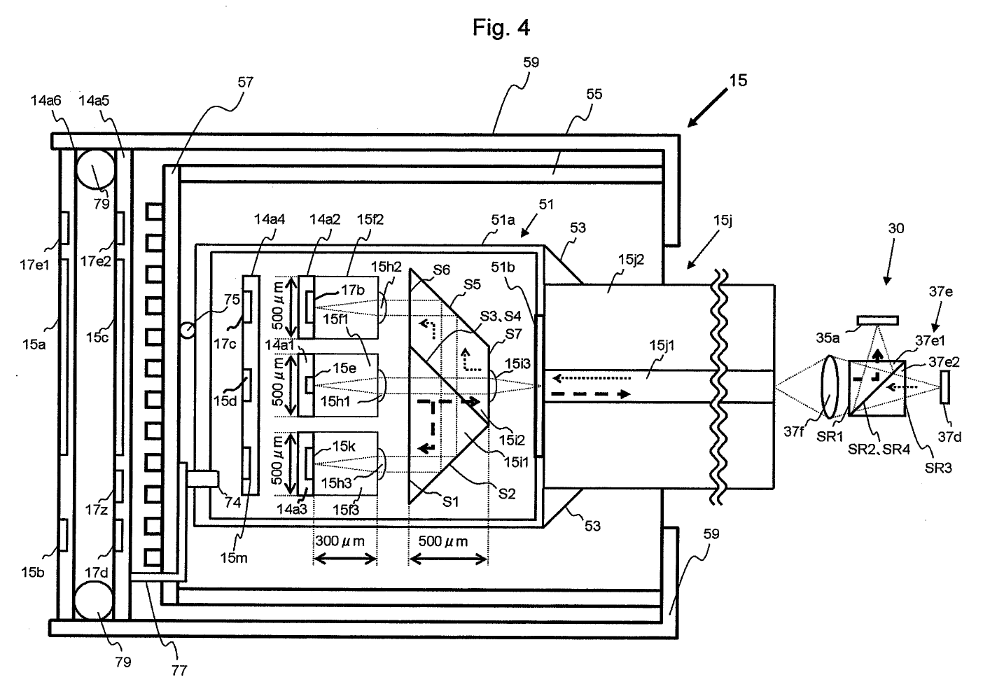

The TG 17e has a sub TG 17e1 and a main TG 17e2 (see FIG. 4).

Transmission of the image signal from the ADC 15c of the electric scope 10 to the DSP circuit 35c of the processor 30 is accomplished via light. Specifically, the image signal is converted to a digital signal by the ADC 15c, is then converted to a serial signal from the parallel signal by the logic IC 17z, and is then converted to an on/off light signal (the light signal) by the video-signal LD driver 15d, whereupon the on/off light signal flashes on and off at the video-signal emitting unit 15e, which in turn is driven by the pulse.

Almost all of the on/off light signal (approximately 90%) then travels through the first glass board 15f1, the first lens 15h1, the first prism 15i1, the second prism 15i2, the scope-side condenser lens 15i3, the optical cable 15j, the processor-side condenser lens 37f, and the wavelength-separation prism 37e before it is received and amplified by the first video-signal photo sensor unit 35a. Next, the signal is decoded by the video-signal PLL decoder 35b, after which the decoded signal undergoes an image signal processing operation performed by the DSP circuit 35c.

Further, a part of the on/off light signal (approximately 10%) then travels through the first glass board 15f1, the first lens 15h1, the first prism 15i1, the third lens 15h3, and the third glass board 15f3 before it is received by the second video-signal photo sensor unit 15k and amplified by the video-signal amplifier 15m. Next, based on the amplified signal, the light quantity of the output (radiated light) that is radiated from the video-signal emitting unit 15e is calculated. Based on the calculation, the light quantity of the output (radiated light) that is radiated from the video-signal emitting unit 15e is adjusted so that the light quantity of the radiated light becomes within an acceptable range. The adjustment calculation for the light quantity is performed by the video-signal LD driver 15d that receives the signal output from the video-signal amplifier 15m.

The imaging unit 15 has a first circuit board 14a1, a second circuit board 14a2, a third circuit board 14a3, a fourth circuit board 14a4, a fifth circuit board 14a5, a sixth circuit board 14a6, a molding package 51, a positioning member 53, a metal case 55, a heat radiation board 57, and a board support unit 59 for the purpose of mounting.

The first circuit board 14a1, the second circuit board 14a2, the third circuit board 14a3, the fourth circuit board 14a4, the fifth circuit board 14a5, and the sixth circuit board 14a6 are arranged parallel to the lens surface of the objective optical system 13. The first, second, and third circuit boards 14a1, 14a2, and 14a3 are arranged on the same plane.

The sixth circuit board 14a6, the fifth circuit board 14a5, the fourth circuit board 14a4, and the first circuit board 14a1 are arranged in order from the objective optical system 13 side.

The fifth and sixth circuit boards 14a5 and 14a6 are attached to the board support unit 59 whose diameter is approximately 3.8 mm.

The first, second, third, and fourth circuit boards 14a1, 14a2, 14a3, and 14a4 are attached to the molding package 51.

In the second embodiment, the first, second, and third circuit boards 14a1, 14a2, and 14a3 are separate from each other; however, they may be combined on one circuit board.

The first circuit board 14a1, the second circuit board 14a2, the third circuit board 14a3, the fourth circuit board 14a4, the video-signal LD driver 15d, the video-signal emitting unit 15e, the first glass board 15f1, the second glass board 15f2, the third glass board 15f3, the first lens 15h1, the second glass lens 15h2, the third lens 15h3, the first prism 15i1, the second prism 15i2, the scope-side condenser lens 15i3, the second video-signal photo sensor unit 15k, the video-signal amplifier 15m, the control-signal photo sensor unit 17b, and the control-signal amplifier 17c are positioned inside of the molding package 51.

The first circuit board 14a1 is electrically connected to the fourth circuit board 14a4 via a plurality of bump balls (not depicted). The second circuit board 14a2 is electrically connected to the fourth circuit board 14a4 via a plurality of bump balls (not depicted). The third circuit board 14a3 is electrically connected to the fourth circuit board 14a4 via a plurality of bump balls (not depicted). The fourth circuit board 14a4 is electrically connected to the fifth circuit board 14a5 via a lead 74 that penetrates the body 51a of the molding package 51 and a flexible circuit board 77 that penetrates the radiation board 57.

The video-signal LD driver 15d, the video-signal amplifier 15m, and the control-signal amplifier 17c are mounted on the fourth circuit board 14a4.

The video-signal emitting unit 15e and the first glass board 15f1 are arranged on the first circuit board 14a1 and on the opposite side of the objective optical system 13. The first circuit board 14a1 is composed of GaAs (Gallium Arsenic) circuit board material.

The second glass board 15f2 and the control-signal photo sensor unit 17b are arranged on the second circuit board 14a2 and on the opposite side of the objective optical system 13.

The third glass board 15f3 and the second video-signal photo sensor unit 15k are arranged on the third circuit board 14a3 and on the opposite side of the objective optical system 13.

The first glass board 15f1 is arranged on the first circuit board 14a1 and covers the video-signal emitting unit 15e. The first lens 15h1 is attached to the first glass board 15f1 on the opposite side of the objective optical system 13.

The second glass board 15f2 is arranged on the second circuit board 14a2 and covers the control-signal photo sensor unit 17b. The second lens 15h2 is attached to the second glass board 15f2 on the opposite side of the objective optical system 13.

The third glass board 15f3 is arranged on the third circuit board 14a3 and covers the second video-signal photo sensor unit 15k. The third lens 15h3 is attached to the third glass board 15f3 on the opposite side of the objective optical system 13.

The first lens 15h1 condenses the light of the video signal output from the video-signal emitting unit 15e, c converts the radiated light to parallel light, and radiates the condensed parallel light to the first prism 15i1.

The second lens 15h2 condenses the light of the control signal output from the control-signal emitting unit 37d, and radiates the condensed light to the control-signal photo sensor unit 17b.

The third lens 15h3 condenses the portion of the light that it receives from the light of the video signal output from the video-signal emitting unit 15e, and then radiates the condensed light to the second video-signal photo sensor unit 15k.

The thickness of the first glass board 15f1, the second glass board 15f2, and the third glass board 15f3 in the direction parallel to the optical axis of the objective optical system 13, is approximately 300 μm.

The thickness of the first glass board 15f1, the second glass board 15f2, and the third glass board 15f3 in the direction perpendicular to the optical axis of the objective optical system 13, is approximately 500 μm.

The first glass board 15f1 is used as the positioning member and focus adjusting member for the first lens 15h1.

The second glass board 15f2 is used as the positioning member and focus adjusting member for the second lens 15h2.

The third glass board 15f3 is used as the positioning member and focus adjusting member for the third lens 15h3.

The first prism 15i1 and the second prism 15i2 combine to form the micro prism. The control signal that is radiated from the control-signal emitting unit 37d is reflected off the walls of the second prism 15i2 and output to the second lens 15h2 from the second prism 15i2.

Almost all of the video signal (approximately 90%) that is radiated from the video-signal emitting unit 15e passes through the walls of the first and second prisms 15i1 and 15i2 and is output to one end of the optical fiber core 15j1 from the second prism 15i2.

A portion of the video signal (approximately 10%) that is radiated from the video-signal emitting unit 15e is reflected by the first prism 15i1 and output to the third lens 15h3 therefrom.

A spacer (not depicted) is arranged between the first glass board 15f1 and the first prism 15i1, so that a constant distance is maintained between the first glass board 15f1 and the first prism 15i1 in the direction parallel to the optical axis of the objective optical system 13.

A spacer (not depicted) is arranged between the second glass board 15f2 and the second prism 15i2, so that a constant distance is maintained between the second glass board 15f2 and the second prism 15i2 in the direction parallel to the optical axis of the objective optical system 13.

A spacer (not depicted) is arranged between the third glass board 15f3 and the first prism 15i1, so that a constant distance is maintained between the third glass board 15f3 and the first prism 15i1 in the direction parallel to the optical axis of the objective optical system 13.

The scope-side condenser lens 15i3 is arranged on the second prism 15i2 and in the optical path of the light radiated from the video-signal emitting unit 15e.

The first prism 15i1 has a first surface S1 that is perpendicular to the optical axis of the objective optical system 13, a second surface S2 that intersects the optical axis of the objective optical system 13 at −45 degrees, and a third surface S3 that intersects the optical axis of the objective optical system 13 at 45 degrees and is perpendicular to the second surface S2.

The first surface S1 of the first prim 15i1 faces the first lens 15h1 and the third lens 15h3.

The shape of the first prism 15i1 viewed from the side is an isosceles right triangle whose oblique side (base of the triangle) is the first surface S1.

The second prism 15i2 has two surfaces (a fourth surface S4 and a fifth surface S5) that intersect the optical axis of the objective optical system 13 at 45 degrees, and two surfaces (a sixth surface S6 and a seventh surface S7) that are perpendicular to the optical axis of the objective optical system 13.

The fourth surface S4 of the second prism 15i2 faces (contacts with) the third surface S3 of the first prism 15i1. The sixth surface S6 of the second prism 15i2 faces the second lens 15h2. The scope-side condenser lens 15i3 is attached to the seventh surface S7 of the second prism 15i2.

The shape of the second prism 15i2 viewed from the side is a parallelogram that consists of these four surfaces (the fourth, fifth, sixth, and seventh surfaces S4, S5, S6, and S7).

A wavelength separation coating and a half-mirror coating are applied to at least one of the third surface S3 of the first prism 15i1 and the fourth surface S4 of the second prism 15i2.

Almost all of the light that is radiated from the video-signal emitting unit 15e, whose oscillating wavelength is long (850 nm, see broken line in FIG. 2), is not reflected by (passes through) the third surface S3 of the first prism 15i1 and the fourth surface S4 of the second prism 15i2.

A portion of the radiated light, that is radiated from the video-signal emitting unit 15e, whose oscillating wavelength is long (850 nm, see broken line in FIG. 2), is reflected by the third surface S3 of the first prism 15i1.

The radiated light, that is radiated from the control-signal emitting unit 37d, whose oscillating wavelength is short (650 nm, see dotted line in FIG. 2), is reflected at the fourth surface S4 of the second prism 15i2.

The thickness of the first prism 15i1 and the second prism 15i2 in the optical axis direction of the objective optical system 13 is approximately 500 μm.

The other construction of the second embodiment is the same as that of the first embodiment. In the second embodiment, because the level of the quantity of light radiated from the video-signal emitting unit 15e is fed back to the second video-signal photo sensor unit 15k and adjusted, a constant level of the quantity of radiated light can be maintained, even if the quantity of light is affected (depleted) by time or temperature variations.

In the second embodiment, in contrast to the first embodiment, the second video-signal photo sensor unit 15k is added. However, by changing the shape of the first prism 15i1 and the coating of the third surface S3 of the first prism 15i1, the video-signal emitting unit 15e, the control-signal photo sensor unit 17b, and the second video-signal photo sensor unit 15k can be mounted on circuit boards (the first and second circuit boards 14a1 and 14a2) that are configured on the same plane. In other words, the emitting surface of the video-signal emitting unit 15e, the receiving surface of the control-signal photo sensor unit 17b, and the receiving surface of the second video-signal photo sensor unit 15k can be parallel.

Thus, the apparatus that transmits light and receives light for the electric scope 10 can be downsized in comparison to the apparatus that transmits light and receives light for the processor 30, where the photo sensor unit is arranged perpendicular to the emitting unit on two perpendicular planes by using the prism and the condenser lens in the processor 30.

Particularly, the depth direction that is parallel to the optical axis direction of the objective optical system 13 can be downsized.

The distal end part of the electric scope 10 is approximately 10 mm in diameter. In consideration of the arrangement of the nozzle, the light guide 11a, and the throat of the forceps, it is desirable for the part housing the imaging unit 15, upon which the CMOS sensor 15a etc. are mounted, to have an appropriate shape and size so that it does not extend beyond the objective optical system 13 that is roughly 4 mm in diameter.

It is necessary to mount the peripheral circuits, such as the CDS 15b etc., near the CMOS sensor when it functions as the imaging sensor. In the first embodiment, however, the circuit board holding these peripheral circuits is oriented perpendicular to the optical axis of the objective optical system 13. Therefore, the peripheral circuits must be arranged accordingly so that the part housing the imaging unit 15 does not extend beyond the lens diameter of the objective optical system 13, despite the addition of the second video-signal photo sensor unit 15k. The diameter of the board support unit 59 is approximately 3.8 mm.

Next, the third embodiment is explained. In the first embodiment, the prism is used for separating the light. However, in the third embodiment, a diffraction device (a diffraction grating) is used for separating the light. The points that differ from the first embodiment are explained as follows.

The lighting unit 11 has a light guide 11a and a lens for lighting 11b.

The imaging unit 15 has a CMOS sensor 15a, a CDS (Correlated Double Sampling) circuit 15b, an ADC (Analog Digital Converter) 15c, a video-signal LD driver 15d, a video-signal emitting unit 15e that is a VCSEL (Vertical Cavity Surface Emitting Laser etc.), a glass board 15f, a lens 15h, an optical cable 15j, first and second control-signal photo sensor units 17b1 and 17b2 that are PDs (Photo Diodes) etc., first and second control-signal amplifiers 17c1 and 17c2, a control-signal PLL decoder 17d, a TG (Timing Generator) 17e, a logic IC 17z, a power supply cable 19a, and a power supply unit 19b.

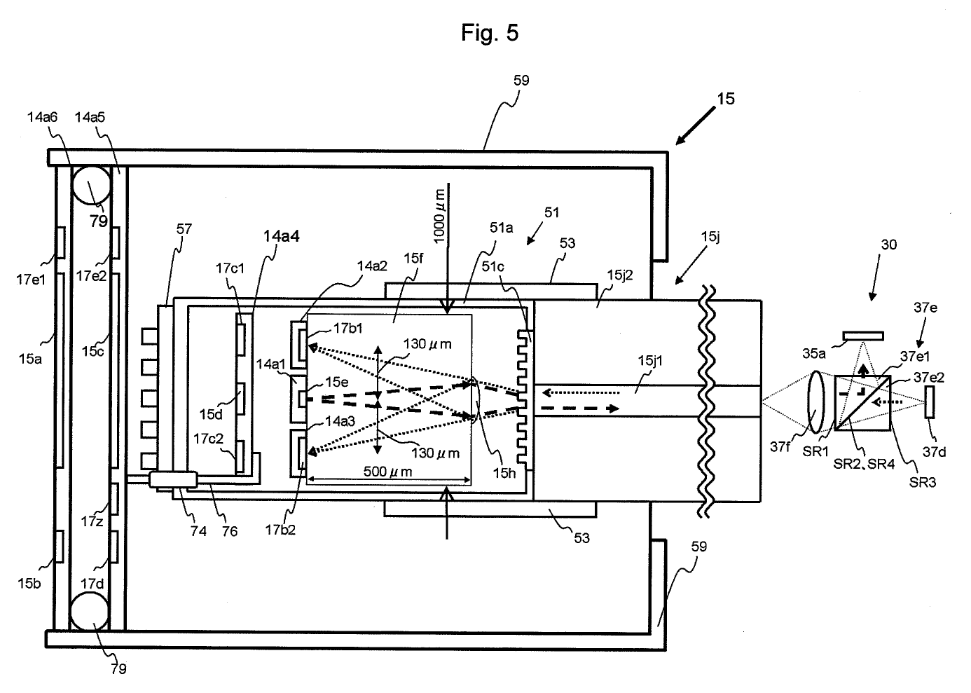

The TG 17e has a sub TG 17e1 and a main TG 17e2 (see FIG. 5).

Transmission of the image signal from the ADC 15c of the electric scope 10 to the DSP circuit 35c of the processor 30 is accomplished via light. Specifically, the image signal is converted to a digital signal by the ADC 15c, is then converted to a serial signal from the parallel signal by the logic IC 17z, and is then converted to an on/off light signal (the light signal) by the video-signal LD driver 15d, whereupon the on/off light signal flashes on and off at the video-signal emitting unit 15e, which in turn is driven by the pulse.

The on/off light signal then travels through the glass board 15f, the lens 15h, the diffraction grating board 51c, the optical cable 15j, the processor-side condenser lens 37f, and the wavelength-separation prism 37e before it is received and amplified by the first video-signal photo sensor unit 35a. Next, the signal is decoded by the video-signal PLL decoder 35b, after which the decoded signal undergoes an image signal processing operation performed by the DSP circuit 35c.

The SSG 37b generates a pulse signal (a synchronizing signal) controlled by the CPU 37a. The synchronizing signal is converted to the on/off light signal based on the pulse of the control-signal LD driver 37c, and the on/off light signal flashes on and off at the control-signal emitting unit 37d that is driven by the pulse.

The on/off light signal travels through the wavelength-separation prism 37e, the processor-side condenser lens 37f, the optical cable 15j, the diffraction grating board 51c, the lens 15h, and the glass board 15f before it is received by the first and second control-signal photo sensor units 17b1 and 17b2 that have photo diodes. The on/off light signals are then amplified by the first and second control-signal amplifiers 17c1 and 17c2. The amplified signals are added together and the added (mixed) signal is decoded by the control-signal PLL decoder 17d.

The optical cable 15j has an optical fiber core 15j1 and an optical fiber protection ferrule 15j2. The diameter of the optical fiber core 15j1 is approximately 200 μm. The diameter of the optical fiber protection ferrule 15j2 that surrounds the optical fiber core 15j1 is approximately 1.25 mm.

One end of the optical fiber core 15j1 faces the video-signal emitting unit 15e through the diffraction grating board 51c, the lens 15h, and the glass board 15f.

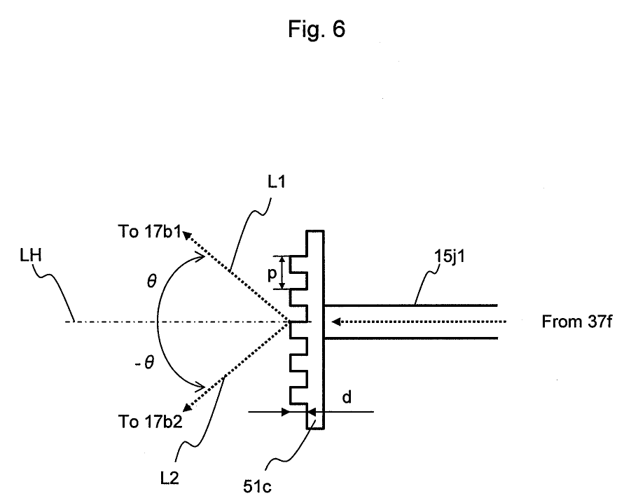

A first oblique line L1 between the center of the area of the diffraction grating board 51c that the video signal passes through, and the center of the area of the receiving surface of the first control-signal photo sensor unit 17b1 that receives the control signal, intersects a horizontal line LH between the center of the area of the diffraction grating board 51c that the video signal passes through and the center of the area of the emitting surface of the video-signal emitting unit 15e at a plus primary (1^{st}) diffraction angle +θ, viewed from a side-view (see FIG. 6).

A second oblique line L2 between the center of the area of the diffraction grating board 51c that the video signal passes through, and the center of the area of the receiving surface of the second control-signal photo sensor unit 17b2 that receives the control signal, intersects the horizontal line LH at a minus primary (1^{st}) diffraction angle −θ, viewed from side (see FIG. 6).

The other end of the optical fiber core 15j1 faces the control-signal emitting unit 37d through the processor-side condenser lens 37f and the wavelength-separation prism 37e.

Through the optical fiber core 15j1, the control signal is transmitted from the processor 30 to the electric scope 10, and the video signal is transmitted from the electric scope 10 to the processor 30.

Next, the mounting part of the CMOS sensor 15a etc. is explained in the third embodiment (see FIG. 5). The part regarding the power supply has been omitted from FIG. 5.

The imaging unit 15 has a first circuit board 14a1, a second circuit board 14a2, a third circuit board 14a3, a fourth circuit board 14a4, a fifth circuit board 14a5, a sixth circuit board 14a6, a molding package 51, a positioning member 53, a heat radiation board 57, and a board support unit 59, for the purpose of mounting.

The first circuit board 14a1, the second circuit board 14a2, the third circuit board 14a3, the fourth circuit board 14a4, the fifth circuit board 14a5, and the sixth circuit board 14a6 are arranged parallel to the lens surface of the objective optical system 13. The first, second, and third circuit boards 14a1, 14a2, and 14a3 are arranged on the same plane.

The sixth circuit board 14a6, the fifth circuit board 14a5, the fourth circuit board 14a4, and the first circuit board 14a1 are arranged in order from the objective optical system 13 side.

The fifth and sixth circuit boards 14a5 and 14a6 are attached to the board support unit 59 whose diameter is approximately 3.8 mm.

The first, second, third, and fourth circuit boards 14a1, 14a2, 14a3, and 14a4 are attached to the molding package 51.

In the third embodiment, the first, second, and third circuit boards 14a1, 14a2, and 14a3 are separate from each other; however, they may be combined on one circuit board.

The molding package 51 is a container (case) that encloses a member that is used for transmitting the video signal and the control signal, such as the glass board 15f etc., and protects it from the outside air by using a resin etc. The molding package 51 has a body 51a and a diffraction grating board 51c.

The diffraction grating board 51c has a window to protect the diffraction surface from stain and breakage.

The light radiated from the video-signal emitting unit 15e passes through the diffraction grating board 51c to the optical fiber core 15j1, as the 0^{th} diffraction light.

The light radiated from the control-signal emitting unit 37d passes through the diffraction grating board 51c to the first and second control-signal photo sensor units 17b1 and 17b2, in a refracted state at the ±1^{st} diffraction angle θ, as the 1^{st} diffraction light.

Referring to FIG. 6, the 1^{st} diffraction angle θ is determined based on the diffraction grating pitch p and the diffraction depth d of the diffraction grating board 51c, and a wavelength λ (=650 nm) of the incident light that is the control signal (θ=Sin⁻¹(m×λ÷p)). The parameter “m” is a diffraction number that is equal to 1 in this case.

Therefore, the position relationship (a difference) between the position of the video-signal emitting unit 15e and the first and second control-signal photo sensor units 17b1 and 17b2 can be adjusted by adjusting the parameters (such as the diffraction grating pitch p etc.) of the 1^{st} diffraction angle θ.

Thus, the distance between the center of the first circuit board 14a1 and the center of the second circuit board 14a2 can be reduced; in other words, the diameter of the molding package 51 can be downsized, in comparison with the construction of the molding package 51 in the first embodiment.

For example, when the diffraction grating pitch p is 2.6 μm, the 1^{st} diffraction angle θ is approximately 14.5 degrees and the distance between the center of the first circuit board 14a1 and the center of the second circuit board 14a2 is approximately 130 μm.

Further, by downsizing the diameter of the molding package 51, the diameter of the molding package can match the diameter of the optical cable 15j (−1.25 mm) in the third embodiment.

When a rectangular-shaped diffraction grating board is used as the diffraction grating board 51c, the maximum diffraction effect of the 1^{st} diffraction light deteriorates in comparison with the maximum diffraction effect of the 0^{th} diffraction light (approximately less than 40% of that of the 0^{th} diffraction light).

In the third embodiment, the arrangement of two control-signal photo sensor units is the ideal configuration because it allows for two received control signals to be added together (mixed), which increases the sensitivity of the photo sensor unit and decreases the effects caused by a deterioration in diffraction. However, only one control-signal photo sensor unit is incorporated in the third embodiment to reduce both the cost of the apparatus and the time required for photo signal data processing.

It is desirable to have certain features of the optical device (the diffraction device), such as the shape of the channel, the bump of the channel, and the inflection rate, adjusted so that the 0^{th} diffraction effect of the wavelength (=850 nm) of the video signal and the 1^{st} diffraction effect of the wavelength (=650 nm) of the control signal are maximized as much as possible.

In the third embodiment, the diffraction grating board 51c has the shape of a rectangular channel, however, it may have another shape such as a blazed diffraction grating or a sine wave-shaped diffraction grating.

The first circuit board 14a1, the second circuit board 14a2, the third circuit board 14a3, the fourth circuit board 14a4, the video-signal LD driver 15d, the video-signal emitting unit 15e, the glass board 15f, the lens 15h, the first control-signal photo sensor unit 17b1, the second control-signal photo sensor unit 17b2, the first control-signal amplifier 17c1, and the second control-signal amplifier 17c2 are positioned inside of the molding package 51.

The first circuit board 14a1 is electrically connected to the fourth circuit board 14a4 via a plurality of bump balls (not depicted). The second circuit board 14a2 is electrically connected to the fourth circuit board 14a4 via a plurality of bump balls (not depicted). The third circuit board 14a3 is electrically connected to the fourth circuit board 14a4 via a plurality of bump balls (not depicted). The fourth circuit board 14a4 is electrically connected to the fifth circuit board 14a5 via a flexible circuit board 76 and a lead 74 that penetrates the heat radiation board 57 and the body 51a of the molding package 51.

The body 51a of the molding package 51 is fixed to the heat radiation board 57 by an adhesive.

The heat radiation board 57 has a heat radiation fin that overhangs to the objective optical system 13 side in the optical axis direction of the objective optical system 13, from a plane of the heat radiation board 57 that is perpendicular to the optical axis of the objective optical system 13. The heat radiation board 57 radiates heat away from the molding package 51.

The fifth circuit board 14a5 is electrically connected to the sixth circuit board 14a6 via bump balls 79.

The molding package 51, the fifth circuit board 14a5, and the sixth circuit board 14a6 are attached to the board support unit 59.

Attached to the side of the molding package 51 is the positioning member 53 that overhangs to the optical cable 15j side in the optical axis direction of the objective optical system 13.

The positioning member 53 has a shape that catches and engages the optical cable 15j with the molding package 51.

The optical cable 15j is inserted into the board support unit 59 and engaged with the positioning member 53 under the condition where the positioning member 53 is attached to the molding package 51, so that the connection between the optical cable 15j and the molding package 51, and the positioning operation for the optical path can both be easily carried out.

The video-signal emitting unit 15e and the glass board 15f are arranged on the opposite side of the first circuit board 14a1 from the objective optical system 13.

The first control-signal photo sensor unit 17b1 and the glass board 15f are arranged on the opposite side of the second circuit board 14a2 from the objective optical system 13.

The second control-signal photo sensor unit 17b2 and the glass board 15f are arranged on the third circuit board 14a3 and on the opposite side of the objective optical system 13.

Next, a transmitting part of the optical signal in the third embodiment is explained.

The glass board 15f is arranged on the first circuit board 14a1 and covers the video-signal emitting unit 15e. The glass board 15f is arranged on the second circuit board 14a2 and covers the first control-signal photo sensor unit 17b1. The glass board 15f is arranged on the third circuit board 14a3 and covers the second control-signal photo sensor unit 17b2.

The lens 15h condenses the light of the video signal output from the video-signal emitting unit 15e, converts the radiated light to parallel light, and radiates the condensed parallel light to the diffraction grating board 51c.

The lens 15h condenses the light of the control signal output from the control-signal emitting unit 37d that is separated in two directions by the diffraction grating board 51c, and radiates one segment of the condensed light to the first control-signal photo sensor unit 17b1 and the other segment of the condensed light to the second control-signal photo sensor unit 17b2.

The thickness of the glass board 15f in the direction parallel to the optical axis of the objective optical system 13, is approximately 500 μm.

The thickness of the glass board 15f in the direction perpendicular to the optical axis of the objective optical system 13, is approximately 1000 μm.

The glass board 15f is used as the positioning member and focus adjusting member for the lens 15h.

The other construction of the third embodiment is the same as that of the first embodiment. In the third embodiment, by using the diffraction grating board 51c to separate the transmitted light, the emitting surface of the video-signal emitting unit 15e and the receiving surface of the first and second control-signal photo sensor units 17b1 and 17b2 can be parallel. Therefore, the video-signal emitting unit 15e, the first control-signal photo sensor unit 17b1, and the second control-signal photo sensor unit 17b2 can be mounted in the narrow area on circuit boards (the first and second circuit boards 14a1 and 14a2) that are configured on the same plane.

Thus, the apparatus that transmits light and receives light for the electric scope 10 can be downsized in comparison to the apparatus that transmits light and receives light for the processor 30, where the photo sensor unit is arranged perpendicular to the emitting unit on two perpendicular planes by using the prism and the condenser lens in the processor 30.

Particularly, the depth direction that is parallel to the optical axis direction of the objective optical system 13 can be downsized.

In the case where one cable is shared for transmitting light from the processor 30 to the electric scope 10 and for transmitting light from the electric scope 10 to the processor 30, the apparatus that separates the light signal traveling in one direction (the video signal) from the signal traveling in the opposite direction (the control signal) is necessary.

In the third embodiment, due to comparatively small space on the electric scope side, the diffraction grating device is used for separating the light signals so that the emitting unit and the photo sensor unit are arranged on the same plane. On the processor side, because space comparatively does exist, the prism is used for separating the light signals so that the emitting unit and the photo sensor unit are perpendicularly arranged on two planes that are perpendicular to each other. Therefore, the transmitting apparatus of the light and the receiving apparatus of the light can be appropriately arranged corresponding to the availability of space.

The distal end part of the electric scope 10 is approximately 10 mm in diameter. In consideration of the arrangement of the nozzle, the light guide 11a, and the throat of the forceps, it is desirable for the part housing the imaging unit 15, upon which the CMOS sensor 15a etc. are mounted, to have an appropriate shape and size so that it does not extend beyond the objective optical system 13 that is roughly 4 mm in diameter.

It is necessary to mount the peripheral circuits, such as the CDS 15b etc., near the CMOS sensor when it functions as the imaging sensor. In the third embodiment, however, the circuit board holding these peripheral circuits is oriented perpendicular to the optical axis of the objective optical system 13. Therefore, the peripheral circuits must be arranged accordingly so that the part housing the imaging unit 15 does not extend beyond the lens diameter of the objective optical system 13. The diameter of the board support unit 59 is approximately 3.8 mm.

In the first, second, and third embodiments, the optical cable is shared for transmitting both the video signal from the electric scope 10 and the control signal from the processor 30 so that the diameter of the cable of the electric scope 10 can be minimized, thus enabling greater flexibility in the cable while reducing the load on the patient.

In the first, second, and third embodiments, as the optical signal transmitting and receiving apparatus, the endoscope system comprises the electric scope 10 and the processor 30. The electric scope 10 is used as the transmitting apparatus for the video signal (as the first transmitting and receiving apparatus). The processor 30 is used as the transmitting apparatus for the control signal (as the second transmitting and receiving apparatus).

However, another optical signal transmitting and receiving apparatus may be used. For example, the projector indicating system that comprises a PC as the transmitting apparatus for the video signal and a projector as the transmitting apparatus for the control signal (remote control signal) may be used.

Further, it is explained that the signal transmitted from the electric scope 10 is the video signal; however, the signal that is transmitted from the electric scope 10 may be another digital signal such as a sound signal, etc.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2006-147812 (filed on May 29, 2006) which is expressly incorporated herein by reference, in its entirety.

1. An optical signal transmitting and receiving apparatus comprising:
a first signal transmitting and receiving unit that has a signal emitting unit that radiates a digitized optical signal and an optical cable that transmits said digitized optical signal from said signal emitting unit; and
a second signal transmitting and receiving unit that has a first signal receiving unit that receives said digitized optical signal from said signal emitting unit through said optical cable and a control-signal emitting unit that radiates a control signal that is converted to an optical signal;
said first signal transmitting and receiving unit having a control-signal receiving unit that receives a radiated light according to said control signal that is radiated from said second signal transmitting and receiving unit, through said optical cable; said signal emitting unit having an emitting surface that is parallel to a receiving surface of said control-signal receiving unit.

2. The optical signal transmitting and receiving apparatus according to claim 1, wherein said first signal transmitting and receiving unit has an optical member that radiates said digitized optical signal from said signal emitting unit to said optical cable and that radiates said radiated light according to said control signal from said optical cable to said control-signal receiving unit, between both of said signal emitting unit and said control-signal receiving unit, and said optical cable.

3. The optical signal transmitting and receiving apparatus according to claim 2, wherein said optical member is a prism that has a separation-coated surface upon which a wavelength separation coating is applied, and that refracts at least one of said digitized optical signals from said signal emitting unit and said radiated light according to said control signal from said control-signal emitting unit through said separation-coated surface.

4. The optical signal transmitting and receiving apparatus according to claim 3, wherein said prism has a mirror-coated surface upon which a half-mirror coating is applied;
said first signal transmitting and receiving unit has a second signal receiving unit that receives a portion of said digitized optical signal from said signal emitting unit through said mirror-coated surface; and
a light quantity of the radiated light of said digitized optical signal from said signal emitting unit is adjusted based on a light quantity of the light received by said second signal receiving unit.

5. The optical signal transmitting and receiving apparatus according to claim 2, wherein said optical member is a diffracting grating device that diffracts at least one of said digitized optical signal from said signal emitting unit and said radiated light according to said control signal from said control-signal emitting unit.

6. The optical signal transmitting and receiving apparatus according to claim 5, wherein said digitized optical signal from said signal emitting unit passes through said optical member; and
said radiated light according to said control signal from said control-signal emitting unit is diffracted by a 1^{st} diffraction of said optical member.

7. The optical signal transmitting and receiving apparatus according to claim 6, wherein said control-signal receiving unit has a first control-signal receiving unit that receives one of two segments of light that has been separated in two directions by said 1^{st} diffraction, and a second control-signal receiving unit that receives the other of said two segments of light; and
information according to said control signal that is received at said first control-signal receiving unit and information according to said control signal that is received at said second control-signal receiving unit are included.

8. The optical signal transmitting and receiving apparatus according to claim 2, wherein said first signal transmitting and receiving unit has a molding package that includes said signal emitting unit, said control-signal receiving unit, and said optical member, positioned inside of said molding package.

9. The optical signal transmitting and receiving apparatus according to claim 8, wherein said first signal transmitting and receiving unit has a positioning member that is attached to said molding package and that engages said optical cable.

10. The optical signal transmitting and receiving apparatus according to claim 9, wherein a diameter of said molding package is greater than a diameter of said optical cable; and
said positioning member is attached to the side of said molding package that makes contact with said optical cable.

11. The optical signal transmitting and receiving apparatus according to claim 9, wherein a diameter of said molding package is almost the same as a diameter of said optical cable; and
said positioning member is attached to the side of said molding package.

12. The optical signal transmitting and receiving apparatus according to claim 1, wherein said signal emitting unit and said control-signal receiving unit are mounted on a circuit board that is configured on one plane.

13. The optical signal transmitting and receiving apparatus according to claim 12, further comprising a cover member that covers said signal emitting unit and said control-signal receiving unit, and that is composed of a glass.

14. The optical signal transmitting and receiving apparatus according to claim 12, wherein said circuit board that is configured on one plane and mounted to said signal emitting unit is a GaAs circuit board;
an emitting surface of said signal emitting unit is covered by said GaAs circuit board; and
said digitized optical signal from said signal emitting unit passes through said GaAs circuit board.

15. The optical signal transmitting and receiving apparatus according to claim 1, wherein said first signal transmitting and receiving unit is an electric scope;
said second signal transmitting and receiving unit is a processor that performs an image processing operation regarding an image signal as said digitized optical signal output from said electric scope; and
said electric scope and said processor comprises an endoscope system.

16. The optical signal transmitting and receiving apparatus according to claim 1, wherein said signal emitting unit radiates a digital signal from which an image signal is converted to an optical signal as said digitized optical signal.
